(19) United States
(12) Patent Application Publication
(10) Pub. No.: US 2022/0356323 A1
(43) Pub. Date: Nov. 10, 2022

(54) SYSTEMS AND METHODS FOR RECYCLING POLYOLEFINS

(71) Applicant: Braskem S.A., Camaçari (BR)

(72) Inventors: Cesar Mariano de Carvalho, São Paulo City (BR); Marcelo Farah, São Paulo (BR)

(73) Assignee: Braskem S.A., Camaçari (BR)

(21) Appl. No.: 17/740,245

(22) Filed: May 9, 2022

Related U.S. Application Data
(60) Provisional application No. 63/185,875, filed on May 7, 2021.

(51) Int. Cl. C08J 11/12

(52) U.S. Cl. CPC C08J 11/12; C08J 2323/06; C08J 2323/12

(57) ABSTRACT

Embodiments relate a method for processing recyclable polymer material. The method may include grinding the recyclable polymer material to produce polymer flake material, washing the polymer flake material, removing contaminants from the polymer flake material with a flake sorter, and removing lightweight materials from the polymer flake material with an elutriator. The method may also include extruding the polymer flake material with a virgin to form an extruded polymer blend, degassing the extruded polymer blend, filtering the extruded polymer blend, and pelletizing the polymer blend. The method may also include passing the polymer blend through a silo with a homogenizer system equipped with hot air insufflation.

### CROSS-REFERENCE TO RELATED APPLICATIONS

This application claims priority to U.S. patent application Ser. No. 63/185,875, filed on May 7, 2021, which is incorporated by reference in its entirety.

### BACKGROUND

The management of the polymer-based material lifecycle is important to maintain balance in a circular economy, particularly in products containing plastics. Plastics are commonly derived from petroleum sources and are generally non-biodegradable, therefor the need to build sustainable and effective post-industrial polymer recycling processes is felt across most industries on an international scale. The creation of a stainable solution to post-industrial and post-consumer polymer processing and recycling will provide a future-focused vision for industries and address environmental and economic concerns. While the need and demand for post-industrial and post-consumer polymer material is great, so is the need and demand for the material to be of great quality. Only then will polymer recycling reduce the use of new material. It may be useful to create a product produced from up to 100% recycled polymer that offers industries an equivalent, or even superior product than that of polymer products made by virgin resins. Unfortunately, reducing plastic waste is a global, serious and complex challenge that requires effective and commercial viable recycling solutions.

Plastics are inexpensive, easy to mold, and lightweight with many commercial applications. Generally, plastics are formed from virgin material, resin produced directly from petrochemical feedstock, such as natural gas or crude oil, which has never been used or processed before. Once the products have outlived their useful lives, they are generally sent to waste disposal such as landfill sites, adding to serious environmental problems, like land, water, and air pollution. In addition, the disposal costs for the post-industrial plastic waste poses an extra burden on processors and manufacturers. Also, there is the consideration that a high demand to produce more virgin resin material places a burden to on an already limited and depleting natural resource.

Post-industrial and post-consumer polymers may be considered recyclable polymer material, in that the polymers may be used in polymer recycling. The use of post-industrial and post-consumer polymers (“plastic waste”) through recycling has a variety of benefits over producing virgin resin. Generally, less energy is required to manufacture an article from recycled materials derived from waste materials and scrap, than from the comparable virgin resin material. Recycling materials may obviate the need for disposing of the materials or product. Moreover, less of the earth's limited resources, such as petroleum, are used to form virgin materials.

Unfortunately, while the economic, environmental, and even political demand for products made from recycled plastic exists, the added value created by conventional recycling methods is comparatively low. As a result, large amounts of used plastics can be only partially returned to the economic cycle. Moreover, conventional methods of recycling plastics tend to produce products with lower quality properties.

In addition to the technological limitations of conventional recycling methods, economic issues also impact the demand for plastic waste-based products. For example, the processes for extrusion of recycled plastic material may involve significant and costly pre-process steps like segregating and beading. The commercial viability of these processes may be impacted when the extrusion process and the product thereof is not of a level of quality as of a virgin resin material.

Even the political landscape impacts the recycling market. When international markets stop investing in domestic recycling streams, waste that would have otherwise gone to foreign recyclers is redirected to domestic landfills. The domestic infrastructure is not equipped to absorb and process the large amount of certain plastics entering in the waste stream, despite the pressure for domestic industries to do so.

Despite the challenges associated with recycling plastic waste such as polyethylene and polypropylene, there is a global push to bring innovative ways of recycling plastic waste to market. It is important to provide opportunities and incentives for industries to use plastic waste in recycling line technology, wherein high-quality plastics may be produced.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for processing recyclable polymer material. The system may include a first processing section and a second processing section. The first processing section may include a grinder configured to receive the recyclable polymer material to produce polymer flake material, a washing unit configured to treat the polymer flake material with at least a washing agent, a flake sorter configured to divide the polymer flake material into at least a sorted polymer flake material and a waste material, and an elutriator configured to separate lightweight materials from the sorted polymer flake material. The second processing section may include an extruder system configured to extrude at least a virgin resin material and the sorted polymer flake material to create an extruded polymer blend, wherein the extruder system comprises a vacuum degasser. The second processing section may also include a pelletizer configured to pelletize the extruded polymer blend and produce a pellet stream, and a silo configured to receive the pellet stream. The silo may include a homogenizer system equipped with hot air insufflation.

In another aspect, embodiments disclosed herein relate a method for processing recyclable polymer material. The method may include grinding the recyclable polymer material to produce polymer flake material, washing the polymer flake material, removing contaminants from the polymer flake material with a flake sorter, and removing lightweight materials from the polymer flake material with an elutriator. The method may also include extruding the polymer flake material with a virgin to form an extruded polymer blend, degassing the extruded polymer blend, filtering the extruded polymer blend, and pelletizing the polymer blend. The method may also include passing the polymer blend through a silo with a homogenizer system equipped with hot air insufflation.

Other aspects and advantages of the claimed subject matter will be apparent from the following description and the appended claims.

### BRIEF DESCRIPTION OF DRAWINGS

FIG. 1 is a schematic of a recycling line operation.

FIG. 2 is a schematic of a first processing section.

FIG. 3 is a schematic of a second procession section.

FIGS. 4A-4C show the effect of the extrusion characteristics on the mechanical properties.

FIG. 5 shows the effect of the extrusion characteristics on the VOC quantities.

FIGS. 6A-6C show the effect of the vacuum on the mechanical properties.

FIG. 7 shows the effect of the vacuum on the VOC quantities.

FIGS. 8A-8C show the effect of the vacuum with post-treatment on the mechanical properties.

FIG. 9 shows the effect of the vacuum with post-treatment on the VOC quantities.

FIGS. 10A-10D show the effect of the pre-treatment on the mechanical properties.

FIG. 11 shows the effect of the pre-treatment on the VOC quantities.

FIGS. 12A-12C show the effect of the complete process on the mechanical properties.

FIG. 13 shows the effect of the complete process on the VOC quantities.

### DETAILED DESCRIPTION

In one aspect, embodiments disclosed herein relate to recycling line systems and methods for recycling polyolefins such as polyethylene and polypropylene. The polyethylene and polypropylene waste designated for recycling may originate from post-industrial and post-consumer plastic waste. Examples of sources of post-industrial plastic waste are equipment manufacturers, processors, and assemblers. The post-consumer plastic is waste produced by end consumers of a material stream; that is, where the waste-producing use did not involve the production of another product. Both sources of polyethylene and polypropylene plastic waste are referred to as “plastic waste.” Thus, embodiments disclosed herein may relate to recycling line systems and methods for recycling a variety of plastic waste from post-industrial and post-consumer waste. It is also envisioned that the recyclable plastic waste may contain polymers such as polyethylene terephthalate (PET); high density polyethylene (HDPE); polyvinyl chloride (PVC); low density polyethylene (LDPE); or polystyrene (PS).

Recycling plastic waste, particularly, polyethylene and polypropylene waste, often requires expensive and burdensome operations. Although demand for recycling this waste exists on an international scale, the recycling process must compete with the high quality and availability of virgin resin. Occasionally, market fluctuations drive the cost of virgin resin to below that of the recycled plastic, driving manufacturers to produce or use virgin resin over investing in the more environmentally sound recycled plastic. To ensure that the plastic recycling supply chain progresses to meet market need, recycling operations may provide a way to produce a recycled plastic material with the same or better properties as that of virgin resin in a streamlined, easy to integrate, and flexible process.

According to embodiments disclosed herein, the recycling line process incorporates recycling operations with innovative techniques comprising extruding virgin resin together with plastic waste to create a product with advantageous properties. Advantages of the present disclosure may include a processing line integrated with a production of blends to produce high performance polymers for a variety of applications.

The recycling line process may comprise two sections, a first processing section for washing and preparing the plastic material and a second processing section for preparing the plastic material in the recycling line. The overall process of the two sections may create a plastic product from recycled plastic waste and virgin resin for use in industrial operations that utilize a variety of plastics.

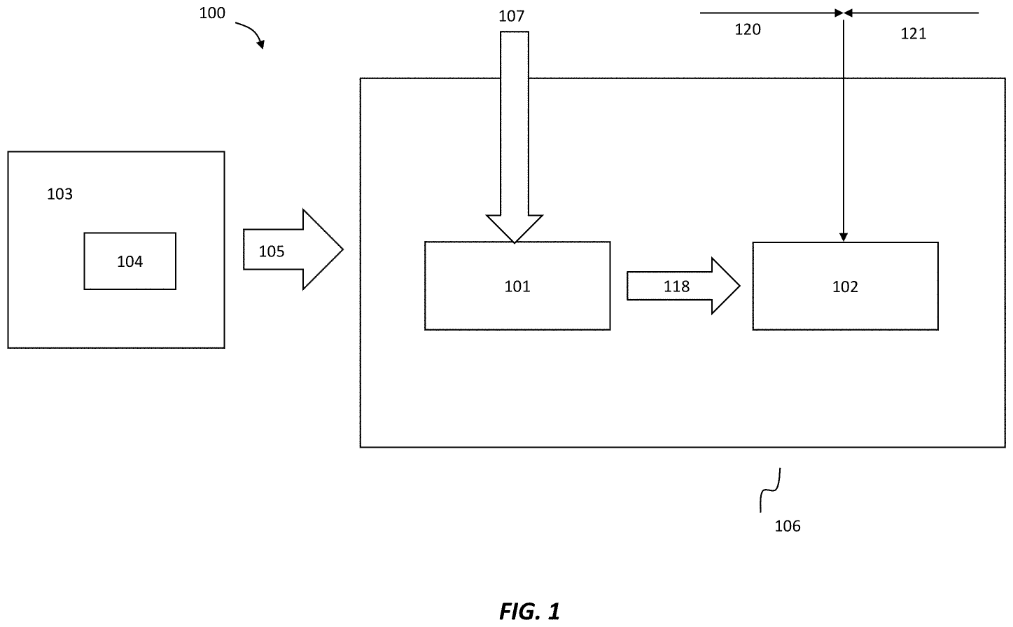

FIG. 1 is a schematic representation of embodiments of the present disclosure. A recycling line operation 100 is shown comprising the first processing section 101 and the second processing section 102. Plastic waste from a landfill 103 is collected at a materials recovery facility 104. The plastic waste is transported using transport systems 105, such as bales and trucking operations, to a recycling facility 106. The recycling facility 106 may also collect plastic waste from other sources 107. The plastic waste from the transport system 105 and plastic waste from other sources 107 enter the recycling facility 106 and both are fed to the recycling line operation 100 to be processed into a recycled plastic product, such as pellets.

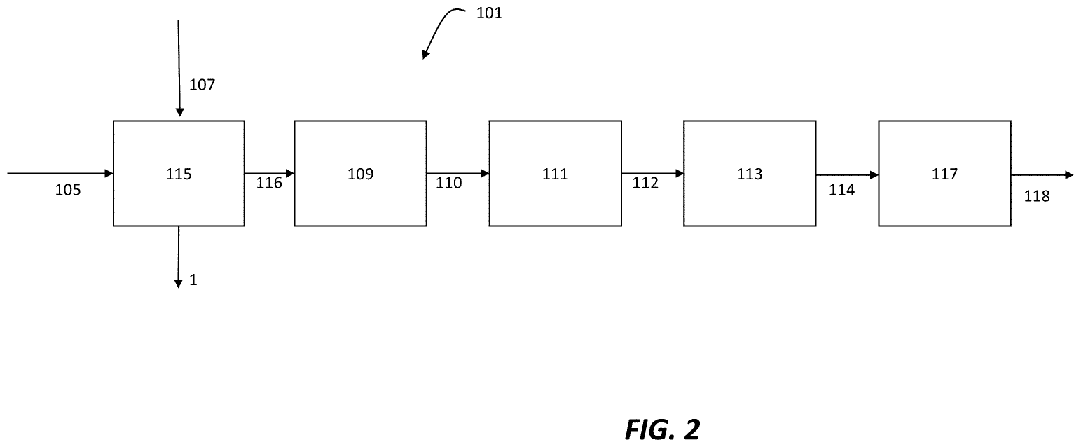

The plastic waste enters the recycling line in the first processing section 101, wherein it is processed in a series of operations. FIG. 2 is exemplary of one order of operations of the first processing section 101 according to at least one embodiment of the present disclosure. The plastic waste from the transport system 105 and other sources 107 enters the elutriation operation 115, wherein lightweight material present in the line with the plastic waste is separated out of the line. Lightweight material may include labels, fines, and other media impurities that may impact the quality of the plastic waste in the first processing section 101. In the elutriation operation 115, this lightweight material may be separated based on size, shape and density, using a stream of gas or liquid flowing in a direction opposite to the direction of the plastic waste flow. An air-deduster (not shown) may be used in embodiments of the present disclosure, wherein the flakes enter the receptacle and air drag on the objects supplies an upward force which counteracts the force of gravity and lifts the lightweight material to be sorted up into the air.

Once lightweight material is removed via line 1 from the first processing section 101, the plastic waste exits the elutriation operation 115 in line 116 and enters a grinding operation 109. A grinding operation 109 grinds the plastic waste using a grinding element (not shown). The grinding element may be a rotator knives grinder, agglomerator, granulator, and preferably a shredder machine. The grinding operation 109 grinds the plastic waste into smaller units, commonly referred to as flakes. Flakes are more uniform in size and allow for a high and regular material flow through the line 110. The grinding operation 109 may also eliminate the need for a manual selection step, or sorting step, prior to grinding wherein material is removed from the line and separated by various properties into skips and bins at the entrance to the grinders, the aim being to isolate and process pre-selected plastic waste. The flakes may be more homogeneous than the plastic waste in line 116 entering the grinding operation 109, thereby making it easier to blend in additives and other polymers in the recycling line process. It may be easier to remove odors and other noxious elements from flakes in the recycling line than larger non-homogeneous plastic waste. The flakes may also be integrated in a more controllable process, such as in closed loop processes. While the elutriation operation 115 is shown as occurring prior to grinding operation 109, in one or more embodiments, the order may be reversed.

Once the plastic waste is grinded into flakes in the grinding operation 109, the flakes enter a washing operation 111 through line 110. The washing operation 111 removes impurities and additional other waste from the flakes. A mixture of water and chemical washing agents, such as detergents, sodas, antifoams, and surfactants may be used in the washing operation 111. The washing operation may be a hot wash, wherein the temperature of the mixture is between 50° C. to 90° C., such as between 60° C. to 80° C. Washing tanks may be utilized in the washing operation as receptacles for the flakes and hot wash. The washed flake may then be rinsed to remove dirt and chemicals used in washing in a rinsing tank (not shown). The washed flakes may then be mechanically dried, for example, by spinning in a centrifuge or hot-air-dried, or any combination of drying methods prior to exiting the washing operation in line 112.

A shown in FIG. 2, once washed and dried, the flakes enter a flake sorter operation 113 via line 112. The flake sorter operation 113 may utilize automated equipment capable of sorting flakes according specified properties to improve the quality of the flakes in the line using wavelength technology or visual sensors, and, in some embodiments, manual sorting. Machines capable of sorting flakes may use sensors, like optical sensors of visible light and near-infrared sensors. For example, a flake sorter machine (not shown) may use NIR, wherein the machine detects wavelength signatures of specific resins to distinguish them from one another and removes contaminants and undesirable material from the line. A flake sorter machine may also use visible light to sort the flake, wherein the machine detects visible light and a high-speed camera or other light sensor to distinguish and sort different colored flake. Selecting the desired properties in the flakes and the appropriate flake sorter machine to achieve those properties may provide an improved quality of the flakes in the recycling line. Examples of controlling properties of flake sorter machines are flake weight, density, shape, and, in the present disclosure, preferably color. Removing undesirable colored flakes from the line may improve the quality and uniformity of the flake. The remaining flakes exit the sorter operation in line 114.

From the flake sorter operation 113, the flakes in line 114 enter a first homogenizing operation 117. The first homogenizing operation 117 mixes, or blends the flakes entering in the line 114 to promote a constant flow, regularity of flake, and uniformity as the flake exits the first homogenizing operation 117 at line 118. The first homogenizing operation 117 is preferably a homogenizing silo-mixer (not shown). A homogenizing silo-mixer is a large receptacle wherein a mixing element, such as a mixing screw, creates a mass flow of dry substances, such as the flake. Gravity and the mixing element blend the flakes by creating space at the bottom of the receptacle so that the flake next to the mixing element falls back down on its own.

The first homogenizing operation 117 may incorporate an air insufflation system (not shown). The air insufflation promotes the removal of volatile organic compounds (“VOC”) by forcing air in a countercurrent through the flakes. In particular embodiments, the air is at a temperature higher than the ambient temperature, known as “hot-air sufflation”.

The order of operations in the first processing section 101 may vary. The order may depend on different factors, such as conditions present in the recycling facility 106, the state of the incoming plastic waste, and desired properties and quality of flake. For example, the lightweights may be removed prior to the flake sorter operation 113. The elutriation operation may be before the grinding operation.

The flake in line 118 may be either collected in a receptacle and transported to the second processing section 102, or the flakes may enter line 118 which may be in fluid connection with the second processing section 102.

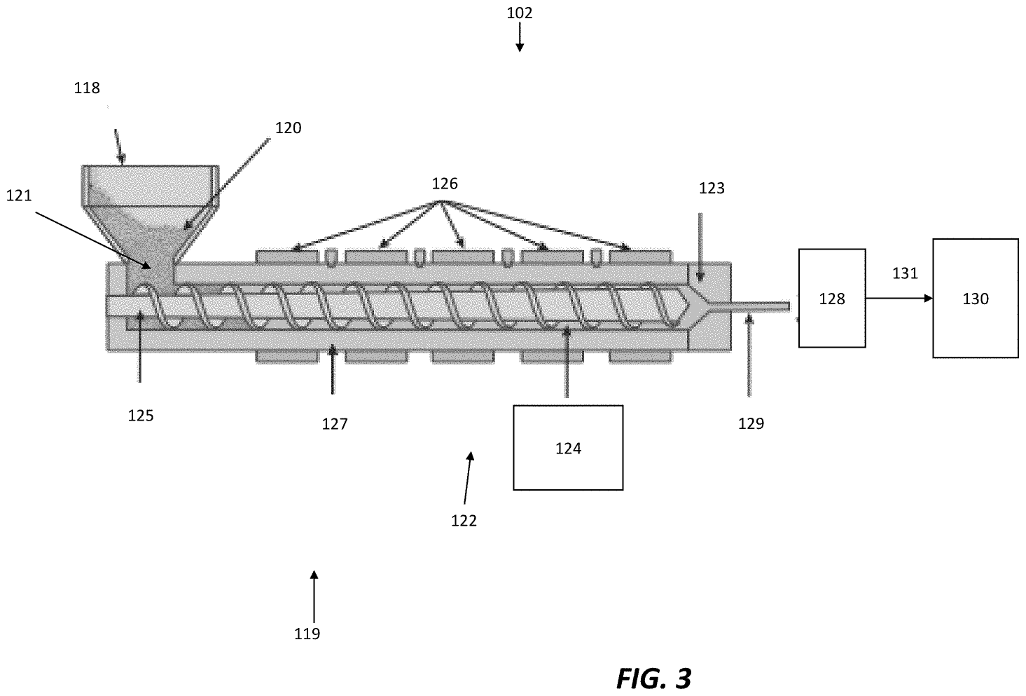

FIG. 3 shows a schematic of an example of the second processing section 102 according to embodiments of the present disclosure. As shown in FIG. 3, the flakes from the first processing section 101 proceed to the second processing section 102. The flakes enter an extrusion operation 119. The extrusion operation 119 comprises at least one extruder, an additive dosing system, a vacuum degassing system, a polymer filter, and a pelletizer. In one or more embodiments, the extrusion operation 119 provides that a virgin resin is extruded with the flakes.

In the extrusion operation 119, the flakes may be cold-blended with at least virgin resin prior to entering the extruder. The cold blend method combines the flakes and virgin resin in a receptacle, such as a silo-mixer prior to extrusion. In embodiments without a cold blend method, the flakes and virgin resin may be blended during extrusion in the extrusion operation.

In some embodiments according to the present disclosure, a hot-blend method may be used to blend the flakes and virgin resin. The hot-blend method may be present in embodiments wherein there is insufficient or lack of a cold-blend method prior to extrusion. As shown in FIG. 3, in the hot-blend method, the flakes enter the extrusion operation in line 118 and into an extrusion operation 119. Virgin resin enters the extrusion operation 119 though line 120. The extrusion operation 119 comprises at least one extruder, and preferably one to four extruders arranged in parallel.

In extruder 122 in FIG. 3 and according to embodiments of the present disclosure, additives may be added to the extruder through dosing line 121. The extruder 122 may be a screw extruder, as evidence by a large screw 125, however a variety of extruders may be used such as a twin screw extruder and a planetary extruder. Once the flakes, virgin resin, and any necessary additives are in the extruder 122, they are moved by a screw 125 in a barrel 127 of the extruder 122 equipped with heaters 126 wherein the contents in the extruder are plasticized by heat and pressure. The plasticized flake, virgin resin, and additives are blended by the conditions in the extruder to a viscous liquid blend.

In one or more embodiments, the extruder length may be greater than 75 mm, such as in a range having a lower limit of any of 80, 100, or 120 mm, and an upper limit of any of 125, 150, 175 or 200 mm. With a longer extruder, the L/D ratio may also be greater than conventional extruders, such as a L/D ratio of any of greater than 32, 35, 38, 40, 42, or 45. The extruder screw may have more than one stage, such as at least two or three stages. Vacuum may be included along the extruder length.

In embodiments of the present disclosure, the virgin resin may constitute 0 to 80 wt %. of the blend. In one or more embodiments, the virgin resin may have a lower limit of any of 0 wt %, 1 wt %, 5 wt %, 10 wt %, 20 wt %, or 30 wt %, and an upper limit of any of 50 wt %, 60 wt %, 70 wt %, or 80 wt %, where any lower limit is used in combination with any upper limit, all relative to the total composition of the blend. The amount and properties of virgin resin used may depend on the end use needs and the properties of the recycled resin. In one or more embodiments, the flakes may constitute 20 to 100 wt % of the blend, such as having a lower limit of any of 20, 30, 40, or 50 wt %, and an upper limit of any of 70 wt %, 80 wt %, 90 wt %, 95 wt %, or 100 wt %, where any lower limit may be used in combination with any upper limit.

The extruder may have at least one system for dosing additives, such as an automatic system of dosing masterbatch, solid additives used for imparting properties to plastics, and liquid additives. Additives are used to add colors, plasticizers, stabilizers, and other basic agents to polymers, which give the final product the desired quality. In some embodiments of the present disclosure, the extruder may have barrel orifices with liquid dispensers. In the present embodiment, the additives in the dosing line 121 may include additives such as stabilizers, antioxidants, nucleating agents, processing air, pigments, and fillers. Other additives may be added in the extrusion operation that encapsulate or extract the VOCs contained in the flakes.

According to embodiments of the present disclosure, a dosing system may be coupled or connected with the extruder. In these embodiments, at least the virgin resin and the flakes may be homogenized prior to dosing in the extruder. In some embodiments of the present disclosure, at least the virgin resin and the flakes may be homogenized in a silo mixer.

According to some embodiments of the present disclosure, the extrusion operation 119 may comprise a vacuum degassing system 124 to remove volatiles and promote a consistently high quality final product. Vacuum degassing promotes the removal of residual moisture, air, monomers, oligomers, solvents, reaction products, and decomposed materials. In the vacuum degassing system 124, a negative pressure may be applied by a vacuum pump to create conditions for removing residual moisture and volatile impurities that adversely affects the properties of the extruded viscous liquid blend comprising flake and virgin resin. The vacuum degassing system 124 may be applied on the viscous liquid blend in the extruder 122 to remove trapped gases, which can create voids and other imperfections in the final product. In some embodiments, a vacuum port may be used on the extruder 122. Part of the way along the extruder 122, the diameter of the screw is reduced to decompress the melt. A vacuum vent may be located at this point for degassing.

The extruder 122 may comprise a polymer filtration system to remove contaminants from the viscous liquid melt in the extruder 122. The filtration system may be a continuous cleaning melt filter, continuous screen changers, slide plate screen changer, or other known filtration systems. Filtration systems prevent contamination by separating the contaminants from the viscous liquid blend without interrupting the production process.

As the viscous liquid blend moves through the extruder 122, it is forced through a die 123 and into at least one stream of polymer blend 129. The die 123 may comprise a number of holes corresponding to a desired number of streams of polymer blend 129.

The die 123 may be equipped with a cutter, or a pelletizer 128. The pelletizer 128 processes the polymer blend 129 coming out of the die 123 with various cutting methods into granules, or pellets. According to conventional cutting methods, such as the spaghetti-cutting method, the polymer blend 129 may be continuously discharged from die 123, form continuous filaments of polymer which, entrained by gears, may be cooled in a water tank and are then cut at a low temperature by rotating knives. This process may help reduce waste, improve handling of the material during transport, as well as aid in odor reduction. In particular, the spaghetti-type cutting method may promote odor removal due to additional exposure time of heated pellets to the atmosphere. Alternatively, a water-ring cutting method may be used in combination with a sorting sieve after the cutting system, wherein the polymer blend 129 is “fired” by high-speed rotating knives in a water-ring circuit separated from the cutting head.

According to embodiments of the present disclosure and as shown in FIG. 3, once the pelletizer 128 cuts and processes the polymer blend 129, the resulting pellets may proceed through line 131 to a second homogenizing operation 130. The second homogenizing operation 130 processes the pellets similarly to first homogenizing operation 117, as previously described. The second homogenizing operation 130 may be a homogenizing silo-mixer. A homogenizing silo-mixer is a large receptacle wherein a mixing element, such as a mixing screw, creates a mass flow of the pellets. Gravity and the mixing element blend the pellets by creating space at the bottom of the receptacle so that the pellets next to the mixing element falls back down on its own.

The second homogenizing operation 130 may incorporate an air insufflation system. The air insufflation promotes the removal of volatile organic compounds (“VOC”) by forcing air in a countercurrent through the pellets. In embodiments of the present disclosure, the air is at a temperature higher than the ambient temperature, commonly referred to as “hot air insufflation”.

The first processing section 101 and second processing section 102 and their unitary operations may be physically separate or in fluid connection. If the first and second processing sections are connected, a silo-mixer may be used to fluidly connect the two sections. The first line may run continuously until it reaches a silo-mixer at the conclusion of the first section, prior to material transfer to the second section. The material may then be held in the silo-mixer for an amount of time before transfer to the second section. Preferably the lines are independent from each other.

According to embodiments of the present disclosure, parameters in the recycling line, including the first processing section and second processing section, may be controlled by a control system, such as at least one computer-controlled feedback control loop. Examples of parameters that may be controlled are flow rates, temperatures, and amperages. An example of a control system is a programmable logic controller (PLC). PLCs are conventional components in industrial automation and control systems. A PLC program may include a set of instructions either in textual or graphical form, which represents the logic to be implemented for specific needs and parameters of the final polymer blend product.

The recycling line may also operate in a closed loop system wherein discarded materials are quickly integrated into the production cycle.

The final pellet product may be packaged and used in subsequent industrial processes, such as in the manufacturing of automotive parts and consumer products.

### EXAMPLES

The following examples are used to exemplify embodiments of the present disclosure. The examples used the recipes shown in Table 1 below:

TABLE 1

| | PCR PE | PCR PP |
|---|---|---|
| Flake | 49% | 59% |
| Virgin | 50% | 40% |
| Black color Masterbatch | 1% | 1% |
| Application | Pipes | Injection molding parts |

The flakes were washed and grinded from landfill sources. Virgin resins included the materials shown in Table 2 below:

TABLE 2

| | Material | Density | MFI* |
|---|---|---|---|
| DP PCR 001 | PP | 0.9 | 40 |
| DA PE PCR 001 | PE | 0.949 | 0.3 |

*MFI PP, 230° C. at 2.16 kg and MFI PE, 190° C. at 5 kg

The flakes were washed and grinded from landfill sources, and then stored in big bags. As the process is continuous and has an intermediary homogenization silo, the big bags from those silos are considered to be representative of a homogeneous sample. The flakes have the general characteristics shown in Table 3 below:

TABLE 3

| | density | MFI (2.16 kg) | MFI (5.0 Kg) |
|---|---|---|---|
| PE flake | 0.96 | 0.3 | 1.46 |
| PP Flake | 0.92 | 11.0 | — |

The samples described below are subjected to one or more of the following:

Air Insufflation pre-treatment—Flakes are subject to air insufflation pre-treatment to remove moisture and volatiles, such as in first homogenizing operation 117 shown in FIG. 2.

Extrusion—An extrusion using longer L/D and screw profile is used to improve the extrusion process, such as in extrusion operation 119 shown in FIG. 3.

Vacuum—A vacuum process is used during extrusion, where the pumps remove the volatiles present in the PCR composition, such as in a vacuum degassing operation 124 shown in FIG. 3.

Air Insufflation post-treatment—Pellets of the composition are being subjected to air insufflation after extrusion to remove also moisture and some additional volatiles generated in the extrusion process, such as in a second homogenizing operation 130 shown in FIG. 3.

With an aim to separate the processes involved, one big bag of flakes was reserved to directly feed the extruder without the insufflation process(pre-treatment), thereby avoiding the more than 10h of heating and volatiles removal of a hot air conditions set-up as described below in Table 4:

TABLE 4

| | Air | Max flake | Flake | Pellets |
|---|---|---|---|---|
| | temperature | temperature | residence | residence |
| | (° C.) | (° C.) | time (h) | time (h) |
| PE | 110 | 70 | 20 | 3 |
| PP | 120 | 80 | 27 | 4 |

These approximated values are an estimation to complete the silo and empty it without a re-feeding process, to a flake silo of 20 m³ and a final insufflation silo of 6 m³, using apparent density of 450 kg/m³ to flakes and 500 kg/m³ to pellets.

### Reference Sample

A Reference Sample was subjected to a simple extrusion, as shown in Table 5 below, with a Rulli Standard 75 mm, L/D 32, with neither degassing nor venting, no mixing screw profile and no post treatment. The reference is a simple system common in the recycling industry.

TABLE 5

| | | Screw | | | Mass | |
|---|---|---|---|---|---|---|
| | Productivity | speed | Torque | Temperature profile | temperature | Pressure |
| Material | (kg/h) | (rpm) | (%) | (° C.) | (° C.) | (bar) |
| PE PCR | 70 | 35 | 75 | 150/205/225/235/245/250/250 | 252 | 117 |
| PP PCR | 28 | 20 | 28 | 140/170/180/185/185/190/230 | 212 | 39 |

### Samples I to V

Samples I to V (of each of PE and PP) were subject to an extrusion using a Wefem Platinum, 150 mm and L/D 41, 3 stages screw, double vacuum(around 400 mmHg) follow the general processing conditions shown in Table 6:

TABLE 6

| | | Screw | | | Mass | |
|---|---|---|---|---|---|---|
| | Productivity | speed | Torque | Temperature profile | temperature | Pressure |
| Material | (kg/h) | (rpm) | (%) | (° C.) | (° C.) | (bar) |
| PE PCR | 900 | 90 | 97 | 240/240/220/220/220/220/190 | 217 | 120 |
| PP PCR | 550 | 90 | 51 | 170/190/190/190/190/190/190 | 205 | 40 |

All sample used the same screen set: 20/60/120/60/40/20 for samples I to V and 60/120/60/40 for sample reference(same reference mesh set to both extruders).

The polypropylene (PP) samples were treated as shown in Table 7.

TABLE 7

| | | | | post |
|---|---|---|---|---|
| | pre-treatment | Extrusion | Vacuum | treatment |
| PP Sample | (117) | (119) | (124) | (130) |
| PP- Reference | | X | | |
| PP- I | | X | X | |
| PP- II | | X | X | X |
| PP- III | | X | | |
| PP- IV | X | X | X | |
| PP- V | X | X | X | X |

The polyethylene (PE) samples were treated as shown in Table 8.

TABLE 8

| | | | | post |
|---|---|---|---|---|
| | pre-treatment | Extrusion | Vacuum | treatment |
| PE Sample | (117) | (119) | (124) | (130) |
| PE- Reference | | X | | |
| PE- I | | X | X | |
| PE- II | | X | X | X |
| PE- III | | X | | |
| PE- IV | X | X | | |
| PE- V | X | X | X | X |

Samples were collected and a portion reserved for volatiles testing by VDA 277: around 200 g were conditioned at metalized bags so as to not lose the volatiles characteristics.

Samples V of PP and PE (those receiving all treatment processes) were collected from the general silo as the equipment operated from more than 4 hours at this condition. A Sample IV of PP was collected before the post treatment silo (second homogenizing operation 130 in FIG. 3). On the other hand, for the PE sample IV, the vacuum pumps were turned on, and after 10 minutes the samples were collected before the post-treatment silo (second homogenizing operation 130 in FIG. 3).

The PP and PE for Sample IV, as compared to the Samples V, allows for a comparison of the effect of the air insufflation plus vacuum and the air insufflation step, respectively.

Using a separated big bag with flake, without pretreatment (such as first homogenizing operation 117 in FIG. 2), Samples III are collected, after 15 minutes using big bag flakes and the vacuum pumps (such as vacuum degassing 124 in FIG. 3) turned-off. Then, the vacuum pump is turned on, and after 15 minutes Samples I are collected. When this last operation has started, the post-treatment silo (such as second homogenizing operation 130 in FIG. 3) was empty and began to receive Samples II like PCR. After 4 hours, the Samples II were collected.

Characterization of the samples was performed according to the protocols shown in Table 9:

TABLE 9

| | |
|---|---|
| MFI | ASTM-D1238 at 2.16 kg and 5 kg at 190° C. for PE samples and |
| | 230° C. and 2.16 kg for PP samples. |
| Density | ASTM D792 |
| Bulk Density | ASTM D 1895 |
| Total Volatiles | VDA-277 |
| | This standard was used to determine the total emissions VOC |
| | (volatiles organic components) in the recycled samples. Lighter |
| | compounds generated during use and polymer reprocessing can |
| | be source of bad smell and decrease the applicability of the |
| | recycled resins. This measurement is an overall quantitative of |
| | possible odor sources and not a qualification of the PCR. |
| | 2 g are weight in a headspace and further heated to 120° C. for |
| | 300 minute and injected. |
| Filterability trial | This internal procedure aims to analyze the dispersion of |
| | impurities and final processability quality of recycled resins. At |
| | a set temperature up to 250° C., Haake single screw extruder at |
| | 50 rpm, the samples were processed using a screen set of |
| | 80/100/120/100/80(mesh). The pressure raising is the criterion |
| | of screen saturation after some time of extrusion and the |
| | increase in the pressure before the screens are reported as |
| | (Δp = bar/kg). |
| Mechanical Properties | |
| Sample preparation | PE uses ASTM D-4703, at 200° C. under pressure. PP uses |
| | ASTM 4101, according to sample MFI. |
| Tensile bar | ASTM D638 |
| Flexural module | ASTM D-790 |
| Izod impact | ASTM D-256 |

### General Characterization

In Table 10 below, the general characterization of the samples generated are shown.

TABLE 10

| | MFI | MFI | Bulk | pellets | |
|---|---|---|---|---|---|
| | 2.16 kg | 5.0 kg | density | count | Filtration |
| | (g/10 min) | (g/10 min) | (g/cm³) | (pellets/g) | (bar/min) |
| PE-reference | 0.12 | 0.54 | 0.582 | 24 | 7.72 |
| PE-I | 0.09 | 0.44 | 0.547 | 38 | 3.30 |
| PE-II | 0.1 | 0.51 | 0.558 | 33 | 26.88 |
| PE-III | 0.09 | 0.44 | 0.562 | 38 | 11.39 |
| PE- IV | 0.11 | 0.51 | 0.556 | 39 | 30.50 |
| PE-V | 0.11 | 0.53 | 0.570 | 32 | 46.69 |
| PP-reference | 17.2 | | 0.5257 | 29 | 4893.99 |
| PP-I | 18.6 | | 0.5453 | 39 | 384.71 |
| PP-II | 17.7 | | 0.5477 | 41 | 553.16 |
| PP-III | 17.4 | | 0.5513 | 42 | 685.81 |
| PP-IV | 23.9 | | 0.5407 | 38 | 254.17 |
| PP-V | 21.2 | | 0.5450 | 38 | 623.25 |

It can be observed that all sample becomes quite similar independently from where it was prepared and the processes involved, being considered the same polymer composition in its own Family. A small difference is observed in pellet size (pellets/g) where the process involving a larger extrusion line brings smaller pellets compared to the reference equipment.

The filtration trials indicated that for the PE sample, the contamination levels do bring a substantial change. Such contamination comes from the PE waste source where the contamination is mainly other polyolefins that still processable.

In the case of PP, the contaminations are from materials with higher Tm and likely cross the screens, thereby remaining in the mixture. An additional benefit is that the improved extrusion process significantly reduced the size of the dispersed phases, by a higher shear and adequate screw profile. This better dispersion due the screw profile improves mechanical properties.

### Example I

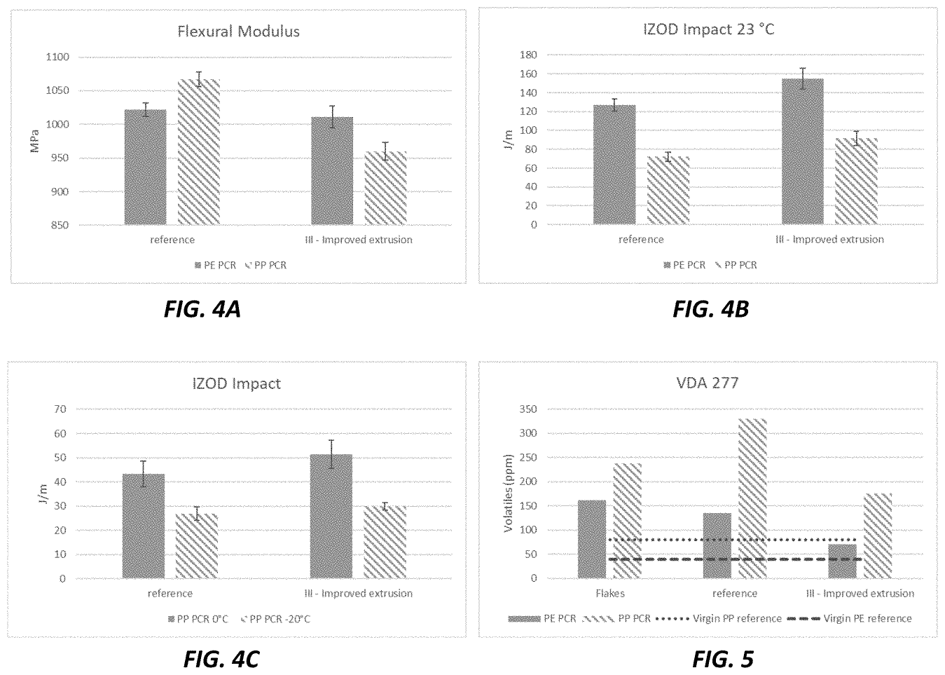

A comparison of the Reference Sample to Sample III for each of PE (left bars) and PP (right bars) aims to express the effect of extruder characteristic (screw profile and L/D). Differences in the general mechanical properties are observed in FIGS. 4A-4C.

It can be observed in the PE PCR sample that there are no significate changes in the stiffness but there is an increase in impact resistance. For the PP samples, there is also an improvement in impact resistance at all temperatures tested, but with some stiffness reduction. In both materials, better dispersion can be the source of the variations.

Regarding the VOCs of the samples, the use of a longer extruder, also an like vent port (without vacuum), generated some reduction in the overall number. The increase in VOC after extrusion instead of addition of virgin resin in composition is well reported. The results of the VOC testing are shown in FIG. 5.

The horizontal lines represent some general numbers measured in virgin HDPE and PP, where in PP the usual values are higher than 80 ppm and in HDPE, over 40 ppm depending on the process technology. The higher values in PCR are also expected are considered the source of odor to recycled resins from different molecules from primary use contamination, additive consumption, etc.

### Example II

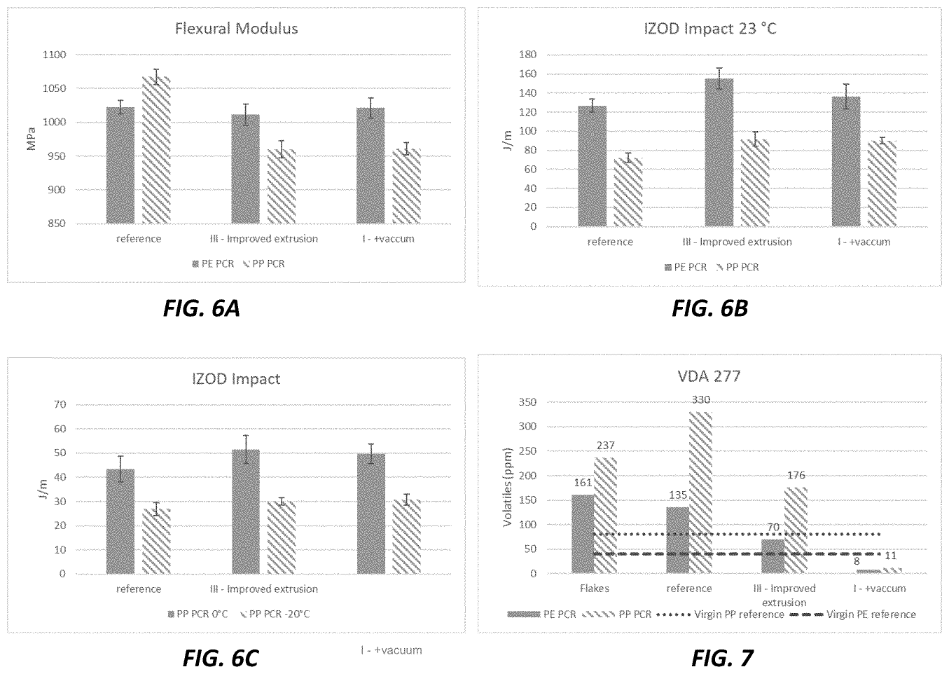

The objective of this example is to consider the double vacuum effect on the samples, considered through a comparison of the reference sample, Sample III and Sample I (PE as left bar, and PP as right bar). Differences in the general mechanical properties are observed in FIGS. 6A-6C.

As expected, the vacuum applied under the PCR production does not change the mechanical properties of the samples. However, a difference can be detected with respect to VOCs, as shown in FIG. 7. The presence of vacuum significantly reduces the VOC amount, which plays as an important role relative to overall PCR improvement. It is very well known that the odor is not only dependent on the amount of VOCs but also the types, where some compounds in the order of ppb (part per billion) are enough to be detectable and considered “bad odor”. So, the VDA 277 is a preliminary evaluation of process efficiency with respect to quantity of volatiles overall.

### Example III

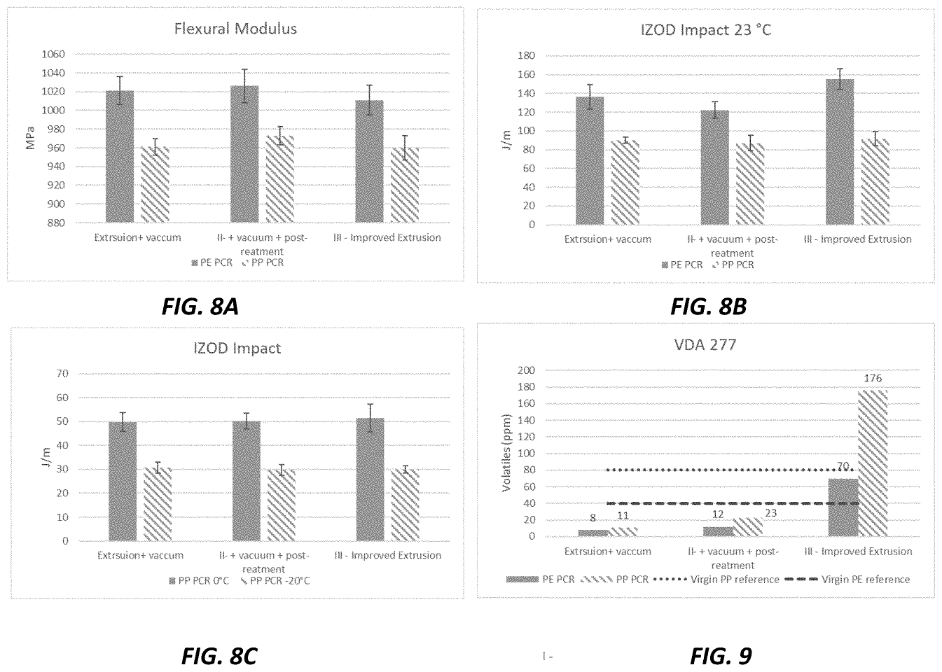

The objective of this example is to consider the effect both vacuum and post-treatment on the samples, considered through a comparison of Samples I, II, and III (PE as left bar, and PP as right bar). Differences in the general mechanical properties are observed in FIGS. 8A-8C. There are no changes in mechanical properties of the samples, indicating that the treatment does not bring any additional degradation in the polymers.

However, a difference can be detected with respect to VOCs, as shown in FIG. 9. The fast-heating time under hot air insuflation probably bring a change in the VOCs composition, removing some products generated in the extrusion and generating others by light molecule decomposition. In general, it is expected that this sample would be considered better in any organoleptic tests.

### Example IV

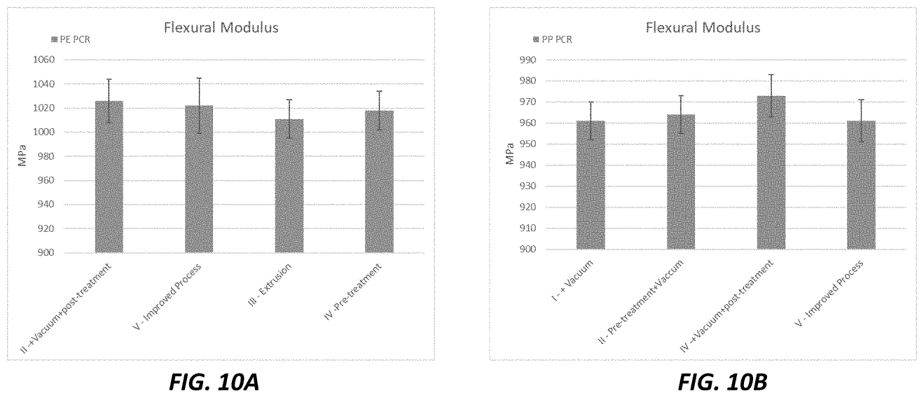

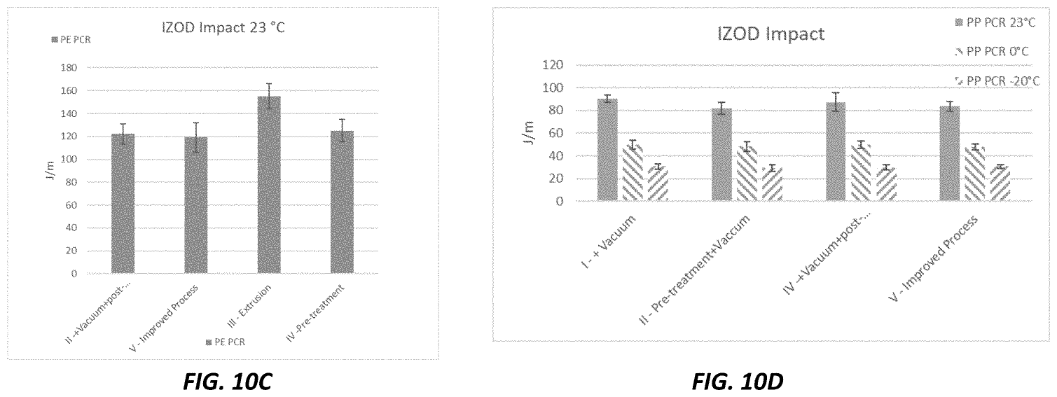

The objective of this example is to consider the effect of pretreatment on the samples, considered through a comparison of various samples (Samples II to V for PE and Samples I, II, IV, and V for PP). Differences in the general mechanical properties are observed in FIGS. 10A-10D, with FIGS. 10A and 10C showing PE and 10B and 10D showing PP (at 23 C. on left, 0 C. in middle and −20 C. on right). In general, the mechanical properties are not affected by the pre-treatment process, that means no severe degradation occurs in the pre-treatment process.

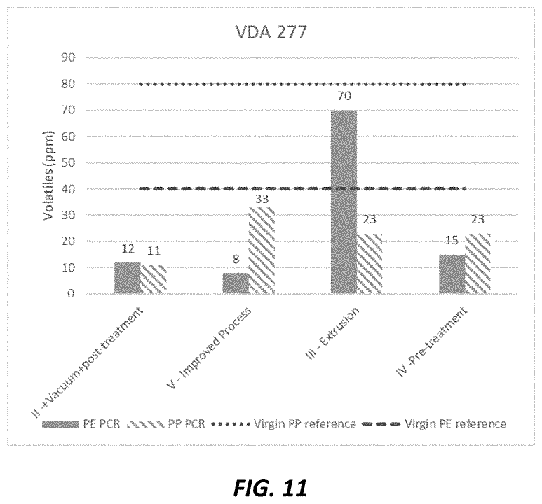

However, a difference can be detected with respect to VOCs, as shown in FIG. 11. With respect to PE, the reduction in VOCs was significant, while in case of PP the pretreatment allowed for degradation of some additives or components.

### Example V

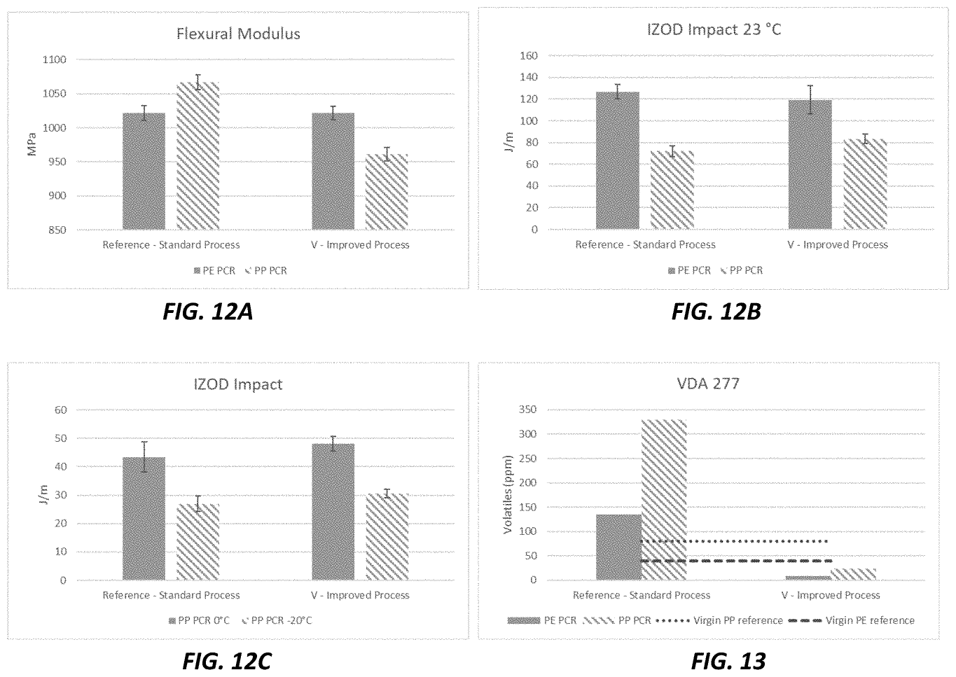

This example seeks to provide complementary evidence of the whole process benefits to reduction in VOCs of the samples being a direct comparison of the reference sample to Sample V, subjected to a complete process with improved extrusion, double vacuum system, pre and post insuflation treatment. From general sample characterization, it is noted that the materials have exactly the same specifications in terms of composition and application processability (PE as left bar, and PP as right bar). Differences in the general mechanical properties are observed in FIGS. 12A-12C. The general improvement in dispersion of the process is only detectable in the impact properties and at lower standard deviation.

A difference can be detected with respect to VOCs, as shown in FIG. 13. It is possible to conclude a significate jump in the volatiles reduction at the PCRs using the combined process of the present disclosure. This reduction is remarkable as it produces levels inferior to virgin resins and thus provides significative benefits to increase the use of PCR in different applications.

Embodiments of the present disclosure may provide at least one of the following advantages. According to embodiments of the present disclosure, the recycling line process presents small overall mass losses. For example, the overall mass loss in the first processing section may be less than 25 wt. %. loss. The overall mass loss in the second processing section may be less than 1 wt. %. loss.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A system for processing recyclable polymer material, the system comprising:
a first processing section comprising:
a grinder configured to receive the recyclable polymer material to produce polymer flake material;
a washing unit configured to treat the polymer flake material with at least a washing agent;
a flake sorter configured to divide the polymer flake material into at least a sorted polymer flake material and a waste material;
an elutriator configured to separate lightweight materials from the sorted polymer flake material;
a second processing section comprising:
an extruder system configured to extrude at least a virgin resin material and the sorted polymer flake material to create an extruded polymer blend, wherein the extruder system comprises a vacuum degasser;
a pelletizer configured to pelletize the extruded polymer blend and produce a pellet stream; and
a silo configured to receive the pellet stream, the silo comprising:
a homogenizer system equipped with hot air insufflation.

2. The system of claim 1, further comprising a homogenizing silo configured to receive the sorted polymer flake material from the first processing section.

3. The system of claim 1, wherein the extruder system comprises a homogenizer system comprising hot air insufflation.

4. The system of claim 1, further comprising a blending element configured to cold blend the virgin resin material with the sorted polymer flake material from the first processing section to create a polymer blend.

5. The system of claim 1, wherein the extruder system further comprises a cleaning melt filter and/or a screen changer.

6. The system of claim 1, wherein the grinder is a shredder machine, rotator knives grinder, or a combination thereof.

7. The system of claim 1, wherein the elutriator is an air-deduster.

8. The system of claim 1, wherein the extruder system comprises:
one extruder or at least two extruders arranged in parallel; and
at least one system for dosing additives into the polymer blend.

9. The system of claim 1, wherein the pelletizer is a spaghetti-type pelletizer or a water-ring pelletizer and optionally comprises a sorting sieve.

10. The system of claim 1, further comprising a control system configured to control the parameters of the first processing section by a programmable logic controller.

11. The system of claim 1, wherein the washing unit is a hot washing at a temperature from 50° C. to 90° C.

12. A method for processing recyclable polymer material, the method comprising:
grinding the recyclable polymer material to produce polymer flake material;
washing the polymer flake material;
removing contaminants from the polymer flake material with a flake sorter;
removing lightweight materials from the polymer flake material with an elutriator;
extruding the polymer flake material with a virgin to form an extruded polymer blend;
degassing the extruded polymer blend;
filtering the extruded polymer blend;
pelletizing the polymer blend; and
passing the polymer blend through a silo with a homogenizer system equipped with hot air insufflation.

13. The method of claim 12, further comprising homogenizing the polymer flake material with hot air insufflation.

14. The method of claim 12, wherein filtering the extruded polymer blend occurs with a continuously cleaning polymer filter.

15. The method of claim 12, further comprising homogenizing the polymer flake material in a mixing chamber.

16. The method of claim 12, further comprising cold blending the sorted polymer flake material and the virgin resin prior to the extruding.

17. The method of claim 12, further comprising dosing additives to the polymer blend.

18. The method of claim 12, wherein the pelletizing is performed by a spaghetti-type pelletizer or a water-ring pelletizer and optionally comprises a sorting sieve.

19. The method of claim 12, further comprising controlling parameters of the grinding, washing, removing contaminants and/or removing lightweight materials with a programmable logic controller.

20. The method of claim 12, wherein the recyclable polymer material is polypropylene or polyethylene.
